(19) United States
(12) Patent Application Publication
(10) Pub. No.: US 2021/0297691 A1
(43) Pub. Date: Sep. 23, 2021

(54) Method and Apparatus of Motion Vector Buffer Management for Video Coding System

(71) Applicant: MEDIATEK INC., Hsinchu City (TW)

(72) Inventors: Tzu-Der CHUANG, Hsinchu City (TW); Ching-Yeh CHEN, Hsinchu City (TW); Zhi-Yi LIN, Hsinchu City (TW)

(21) Appl. No.: 17/253,306

(22) PCT Filed: Jun. 20, 2019
(86) PCT No.: PCT/CN2019/092079

§ 371 Date: Dec. 17, 2020

Related U.S. Application Data
(60) Provisional application No. 62/764,748, filed on Aug. 15, 2018.
(60) Provisional application No. 62/717,162, filed on Aug. 10, 2018.
(60) Provisional application No. 62/687,291, filed on Jun. 20, 2018.

(51) Int. Cl. H04N 19/52; H04N 19/105; H04N 19/159; H04N 19/176; H04N 19/543; H04N 19/423; H04N 19/96

(52) U.S. Cl. CPC H04N 19/52; H04N 19/105; H04N 19/159; H04N 19/96; H04N 19/543; H04N 19/423; H04N 19/176

(57) ABSTRACT

Methods and apparatus of Inter prediction using coding modes including an affine mode are disclosed. According to one method, if the target neighbouring block is in a neighbouring region of the current block, an affine control-point MV candidate is derived based on two target MVs (motion vectors) of the target neighbouring block where the affine control-point MV candidate is based on a 4-parameter affine model and the target neighbouring block is coded in a 6-parameter affine mode. According to another method, if the target neighbouring block is in a neighbouring region of the current block, an affine control-point MV candidate is derived based on two sub-block MVs (motion vectors) of the target neighbouring block, if the target neighbouring block is in a same region as the current block, the affine control-point MV candidate is derived based on control-point MVs of the target neighbouring block.

### CROSS REFERENCE TO RELATED APPLICATIONS

The present invention claims priority to U.S. Provisional Patent Application, Ser. No. 62/687,291, filed on Jun. 20, 2018, U.S. Provisional Patent Application, Ser. No. 62/717,162, filed on Aug. 10, 2018 and U.S. Provisional Patent Application, Ser. No. 62/764,748, filed on Aug. 15, 2018. The U.S. Provisional Patent Applications are hereby incorporated by reference in their entireties.

### FIELD OF THE INVENTION

The present invention relates to video coding using motion estimation and motion compensation. In particular, the present invention relates to motion vector buffer management for coding systems using motion estimation/compensation techniques including affine transform motion model.

### BACKGROUND AND RELATED ART

Various video coding standards have been developed over the past two decades. In newer coding standards, more powerful coding tools are used to improve the coding efficiency. High Efficiency Video Coding (HEVC) is a new coding standard that has been developed in recent years. In the High Efficiency Video Coding (HEVC) system, the fixed-size macroblock of H.264/AVC is replaced by a flexible block, named coding unit (CU). Pixels in the CU share the same coding parameters to improve coding efficiency. A CU may begin with a largest CU (LCU), which is also referred as coded tree unit (CTU) in HEVC. In addition to the concept of coding unit, the concept of prediction unit (PU) is also introduced in HEVC. Once the splitting of CU hierarchical tree is done, each leaf CU is further split into one or more prediction units (PUs) according to prediction type and PU partition.

In most coding standards, adaptive Inter/Intra prediction is used on a block basis. In the Inter prediction mode, one or two motion vectors are determined for each block to select one reference block (i.e., uni-prediction) or two reference blocks (i.e., bi-prediction). The motion vector or motion vectors are determined and coded for each individual block. In HEVC, Inter motion compensation is supported in two different ways: explicit signalling or implicit signalling. In explicit signalling, the motion vector for a block (i.e., PU) is signalled using a predictive coding method. The motion vector predictors correspond to motion vectors associated with spatial and temporal neighbours of the current block. After a MV predictor is determined, the motion vector difference (MVD) is coded and transmitted. This mode is also referred as AMVP (advanced motion vector prediction) mode. In implicit signalling, one predictor from a candidate predictor set is selected as the motion vector for the current block (i.e., PU). Since both the encoder and decoder will derive the candidate set and select the final motion vector in the same way, there is no need to signal the MV or MVD in the implicit mode. This mode is also referred as Merge mode. The forming of predictor set in Merge mode is also referred as Merge candidate list construction. An index, called Merge index, is signalled to indicate the predictor selected as the MV for current block.

Motion occurs across pictures along temporal axis can be described by a number of different models. Assuming A(x, y) be the original pixel at location (x, y) under consideration, A′ (x′, y′) be the corresponding pixel at location (x′, y′) in a reference picture for a current pixel A(x, y), the affine motion models are described as follows.

In contribution ITU-T13-SG16-C1016 submitted to ITU-VCEG (Lin, et al., “Affine transform prediction for next generation video coding”, ITU-U, Study Group 16, Question Q6/16, Contribution C1016, September 2015, Geneva, CH), a four-parameter affine prediction is disclosed, which includes the affine Merge mode. When an affine motion block is moving, the motion vector field of the block can be described by two control-point motion vectors or four parameters as follows, where (vx, vy) represents the motion vector:

$$\{ \begin{matrix}{x}^{′} = ax + by + e \\ {y}^{′} = - bx + ay + f \\ vx = x - {x}^{′} \\ vy = y - {y}^{′}\end{matrix} {⟹}^{△} \{ \begin{matrix}vx = ( 1 - a ) x - by - e \\ vy = ( 1 - a ) y + bx - f\end{matrix} . \qquad ( 2 )$$

An example of the four-parameter affine model is shown in FIG. 1A. The transformed block is a rectangular block. The motion vector field of each point in this moving block can be described by the following equation:

$$\{ \begin{matrix}{v}_{x} = \frac{( {v}_{1 x} - {v}_{0 x} )}{w} x - \frac{( {v}_{1 y} - {v}_{0 y} )}{w} y + {v}_{0 x} \\ {v}_{y} = \frac{( {v}_{1 y} - {v}_{0 y} )}{w} x + \frac{( {v}_{1 x} - {v}_{0 x} )}{w} y + {v}_{0 y}\end{matrix} . \qquad ( 3 a )$$

In the above equations, (v₀ₓ, v_{0y}) is the control-point motion vector (i.e., v₀) at the upper-left corner of the block, and (v₁ₓ, v_{1y}) is another control-point motion vector (i.e., v₁) at the upper-right corner of the block. When the MVs of two control points are decoded, the MV of each 4×4 block of the block can be determined according to the above equation. In other words, the affine motion model for the block can be specified by the two motion vectors at the two control points. Furthermore, while the upper-left corner and the upper-right corner of the block are used as the two control points, other two control points may also be used. An example of motion vectors for a current block can be determined for each 4×4 sub-block based on the MVs of the two control points as shown in FIG. 1B according to equation (3a).

The 6-parameter affine model can also be used. The motion vector field of each point in this moving block can be described by the following equation.

$$\{ \begin{matrix}{v}_{x} = \frac{( {v}_{1 x} - {v}_{0 x} )}{w} x + \frac{( {v}_{2 x} - {v}_{0 x} )}{h} y + {v}_{0 x} \\ {v}_{y} = \frac{( {v}_{1 y} - {v}_{0 y} )}{w} x + \frac{( {v}_{2 y} - {v}_{0 y} )}{h} y + {v}_{0 y}\end{matrix} \qquad ( 3 b )$$

In the above equation, (v₀ₓ, v_{0y}) is the control point motion vector on top left corner, (v₁ₓ, v_{1y}) is another control point motion vector on above right corner of the block, (v₂ₓ, v_{2y}) is another control point motion vector on bottom left corner of the block.

In contribution ITU-T13-SG16-C1016, for an Inter mode coded CU, an affine flag is signalled to indicate whether the affine Inter mode is applied or not when the CU size is equal to or larger than 16×16. If the current block (e.g., current CU) is coded in affine Inter mode, a candidate MVP pair list is built using the neighbour valid reconstructed blocks. FIG. 2 illustrates the neighbouring block set used for deriving the corner derived affine candidate. As shown in FIG. 2, the [symbol] corresponds to motion vector of the block V0 at the upper-left corner of the current block 210, which is selected from the motion vectors of the neighbouring block a0 (referred as the above-left block), a1 (referred as the inner above-left block) and a2 (referred as the lower above-left block), and the [symbol] corresponds to motion vector of the block V1 at the upper-right corner of the current block 210, which is selected from the motion vectors of the neighbouring block b0 (referred as the above block) and b1 (referred as the above-right block). The index of candidate MVP pair is signalled in the bit stream. The MV difference (MVD) of the two control points are coded in the bitstream.

In ITU-T13-SG16-C-1016, an affine Merge mode is also proposed. If current is a Merge PU, the neighbouring five blocks (c0, b0, b1, c1, and a0 blocks in FIG. 2) are checked whether one of them is affine Inter mode or affine Merge mode. If yes, an affine_flag is signalled to indicate whether the current PU is affine mode. When the current PU is applied in affine Merge mode, it gets the first block coded with affine mode from the valid neighbour reconstructed blocks. The selection order for the candidate block is from left, above, above right, left bottom to above left (c0→b0→b1→c1→a0) as shown in FIG. 2. The affine parameters of the first affine coded block is used to derive the v₀ and v₁ for the current PU.

In HEVC, the decoded MVs of each PU are down-sampled with a 16:1 ratio and stored in the temporal MV buffer for the MVP derivation for the following frames. For a 16×16 block, only the top-left 4×4 MV is stored in the temporal MV buffer and the stored MV represents the MV of the whole 16×16 block.

### BRIEF SUMMARY OF THE INVENTION

Methods and apparatus of Inter prediction for video coding performed by a video encoder or a video decoder that utilizes MVP (motion vector prediction) to code MV (motion vector) information associated with a block coded with coding modes including an affine mode are disclosed. According to one method, input data related to a current block at a video encoder side or a video bitstream corresponding to compressed data including the current block at a video decoder side are received. A target neighbouring block from a neighbouring set of the current block is determined, where the target neighbouring block is coded according to a 4-parameter affine model or a 6-parameter affine model. If the target neighbouring block is in a neighbouring region of the current block, an affine control-point MV candidate is derived based on two target MVs (motion vectors) of the target neighbouring block where the affine control-point MV candidate derivation is based on a 4-parameter affine model. An affine MVP candidate list is generated where the affine MVP candidate list comprises the affine control-point MV candidate. The current MV information associated with an affine model is encoded using the affine MVP candidate list at the video encoder side or the current MV information associated with the affine model is decoded at the video decoder side using the affine MVP candidate list.

A region boundary associated with the neighbouring region of the current block may correspond to a CTU boundary, CTU-row boundary, tile boundary, or slice boundary of the current block. The neighbouring region of the current block may correspond to an above CTU (coding tree unit) row of the current block or one left CTU column of the current block. In another example, the neighbouring region of the current block corresponds to an above CU (coding unit) row of the current block or one left CU column of the current block.

In one embodiment, the two target MVs of the target neighbouring block correspond to two sub-block MVs of the target neighbouring block. For example, the two sub-block MVs of the target neighbouring block correspond to a bottom-left sub-block MV and a bottom-right sub-block MV of the neighbouring block. The two sub-block MVs of the target neighbouring block can be stored in a line buffer. For example, one row of MVs above the current block and one column of MVs to a left side of the current block can be stored in the line buffer. In another example, one bottom row of MVs of an above CTU row of the current block are stored in the line buffer. The two target MVs of the target neighbouring block may also correspond to two control-point MVs of the target neighbouring block.

The method may further comprise deriving the affine control-point MV candidate and including the affine control-point MV candidate in the affine MVP candidate list if the target neighbouring block is in a same region as the current block, where the affine control-point MV derivation is based on a 6-parameter affine model or the 4-parameter affine model. The same region corresponds to a same CTU row.

In one embodiment, the y-term parameter of MV x-component and x-term parameter is equal to MV y-component multiplied by (−1), and x-term parameter of MV x-component and y-term parameter of MV y-component are the same for the 4-parameter affine model. In another embodiment, y-term parameter of MV x-component and x-term parameter of MV y-component are different, and x-term parameter of MV x-component and y-term parameter of MV y-component are also different for the 6-parameter affine model.

According to another method, if the target neighbouring block is in a neighbouring region of the current block, an affine control-point MV candidate is derived based on two sub-block MVs (motion vectors) of the target neighbouring block. If the target neighbouring block is in a same region as the current block, the affine control-point MV candidate is derived based on control-point MVs of the target neighbouring block.

For the second method, if the target neighbouring block is a bi-predicted block, bottom-left sub-block MVs and bottom-right sub-block MVs associated with list 0 and list 1 reference pictures are used for deriving the affine control-point MV candidate. If the target neighbouring block is in the same region as the current block, the affine control-point MV candidate derivation corresponds to a 6-parameter affine model or a 4-parameter affine model depending on the affine mode of the target neighbouring block.

### BRIEF DESCRIPTION OF THE DRAWINGS

FIG. 1A illustrates an example of the four-parameter affine model, where the transformed block is still a rectangular block.

FIG. 1B illustrates an example of motion vectors for a current block determined for each 4×4 sub-block based on the MVs of the two control points.

FIG. 2 illustrates the neighbouring block set used for deriving the corner derived affine candidate.

FIG. 3 illustrates an example of affine MVP derivation by storing one more MV row and one more MV column for the first row/first column MVs of a CU according to one embodiment of the present invention.

FIG. 4A illustrates an example of affine MVP derivation by storing M MV rows and K MV columns according to one embodiment of the present invention.

FIG. 4B illustrates another example of affine MVP derivation by storing M MV rows and K MV columns according to one embodiment of the present invention.

FIG. 5 illustrates an example of affine MVP derivation by storing one more MV row and one more MV column for the first row/first column MVs of a CU according to one embodiment of the present invention.

FIG. 6 illustrates an example of affine MVP derivation using only two MVs of a neighbouring block according to one embodiment of the present invention.

FIG. 7 illustrates an example of affine MVP derivation using bottom row MVs of the above CTU row according to one embodiment of the present invention.

FIG. 8A illustrates an example of affine MVP derivation using only two MVs of a neighbouring block according to one embodiment of the present invention, where

FIG. 8B illustrates another example of affine MVP derivation using only two MVs of a neighbouring block according to one embodiment of the present invention.

FIG. 9A illustrates an example of affine MVP derivation using additional MV from the neighbouring MVs according to one embodiment of the present invention.

FIG. 9B illustrates another example of affine MVP derivation using additional MV from the neighbouring MVs according to one embodiment of the present invention.

FIG. 10 illustrates an exemplary flowchart for a video coding system with an affine Inter mode incorporating an embodiment of the present invention, where the affine control-point MV candidate is derived based on two target MVs (motion vectors) of the target neighbouring block and the affine control-point MV candidate is based on a 4-parameter affine model.

FIG. 11 illustrates another exemplary flowchart for a video coding system with an affine Inter mode incorporating an embodiment of the present invention, where the affine control-point MV candidate is derived based on stored control-point motion vectors or sub-block motion vector depending on whether the target neighbouring block is in the neighbouring region or the same region of the current block.

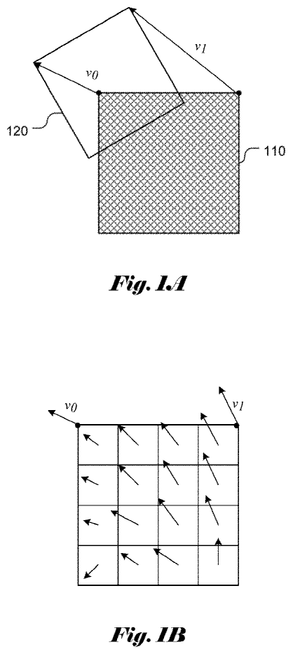

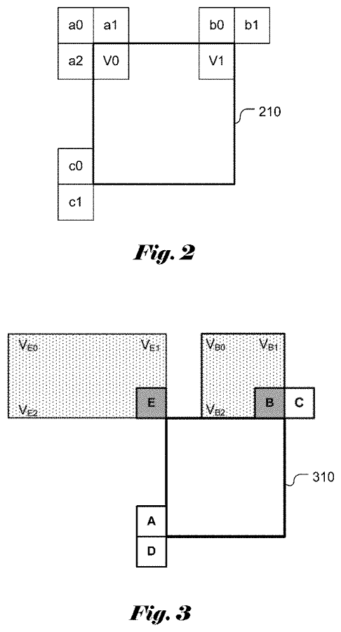

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

In the existing video systems, the motion vectors of previously coded blocks are stored in a motion vector buffer for use by subsequent blocks. For example, the motion vector in the buffer can be used to derive a candidate for a Merge list or an AMVP (advanced motion vector prediction) list for Merge mode or Inter mode respectively. When affine motion estimation and compensation is used, the motion vectors (MVs) associated with the control points are not stored in the MB buffer. Instead, the control-point motion vectors (CPMVs) are stored other buffer separated from the MV buffer. When an affine candidate (e.g. an affine Merge candidate or an affine Inter candidate) is derived, CPMVs of neighbouring blocks have to be retrieved from the other buffer. In order to reduce the required storage and/or CPMVs access, various techniques are disclosed.

In ITU-T13-SG16-C-1016, the affine MVP are derived for affine Inter mode and affine Merge mode. In ITU-T13-SG16-C-1016, for affine Merge mode of a current block, if the neighbouring block is affine coded block (including affine Inter mode block and affine Merge mode block), the MV of top-left N×N (e.g., the smallest block size to store an MV, and N=4) block of the neighbouring block and the MV of the top-right N×N block of the neighbouring block are used to derive the affine parameters or the MVs of the control points of the affine merge candidate. When the third control point is used, the MV of bottom-left N×N block is also used. For example, as shown in FIG. 3, the neighbouring blocks B and E of the current block 310 are affine coded blocks. To derive the affine parameters of block B and block E, the MVs of V_{B0}, V_{B1}, V_{E0} and V_{E1} are required. Sometimes, V_{B2} and V_{E2} are required if the third control point is needed. However, in HEVC, only MVs of the neighbouring 4×4 block row and 4×4 block column of the current CU/CTU/CTU-row and the MVs of current CTU are stored in a line buffer for quick access. Other MVs are down-sampled and stored in a temporal MV buffer for the following frames or discarded. Therefore, if the block-B and block E are in the above CTU row, the V_{B0}, V_{B1}, V_{E0}, V_{E1} are not stored in any buffer in the original codec architecture. It requires additional MV buffers to store the MVs of neighbouring blocks for affine parameter derivation.

In order to overcome this MV buffer issue, various methods of MV buffer management are disclosed to reduce the buffer requirements.

### Method-1: Affine MVP Based on Down-Sampled MV in Temporal MV Buffer

If the MVs are not in the neighbouring block row or block column of the current CU/CTU or in the current CTU/CTU-row (e.g. the referenced MV is not in the neighbouring N×N block row or N×N block column of the current CU/CTU or in the current CTU/CTU-row), the affine parameter derivation uses the MVs stored in the temporal MV buffer instead of the real MVs. Here N×N represents the smallest block size to store an MV. In one embodiment, N=4.

### Method-2: Affine MVP Derivation by Storing M MV Rows and K MV Columns

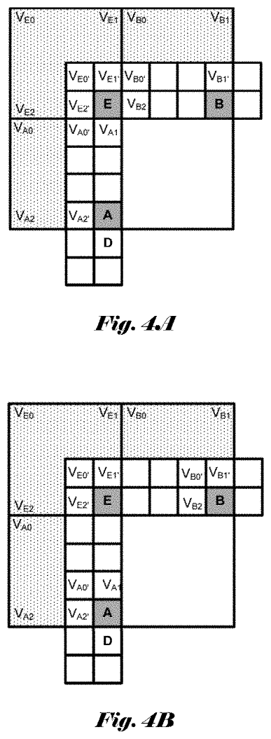

Instead of storing all MVs in the current frame, according to this method, the MVs of M neighbouring row blocks and the MVs of K neighbouring column blocks are stored for affine parameter derivation, where M and K are integer numbers, M can be larger than 1 and K can be larger than 1. Each block refers to the smallest N×N block that an associated MV (N=4 in one embodiment) can be stored. An example with M=K=2 and N=4 is shown in FIG. 4. In FIG. 4A, in order to derive the affine parameters of block B, E, and A, the V_{B0′} and V_{B1′} are used instead of V_{B0} and V_{B1}. The V_{E0′}, V_{E1′} and V_{E2′} are used instead of V_{E0}, V_{E1} and V_{E2}. The V_{A0′} and V_{A2′} are used instead of V_{A0} and V_{A2}. In FIG. 4B, in order to derive the affine parameters of block B, E, and A, the V_{B0′}, V_{B1′} and V_{B2′} are used instead of V_{B0}, V_{B1} and V_{B2}. The V_{E0′}, V_{E1′} and V_{E2′} are used instead of V_{E0}, V_{E1} and V_{E2}. The V_{A0′} and V_{A2′} are used instead of V_{A0} and V_{A2}. In general, other positions in the two row blocks and two column blocks can be used for affine parameter derivation. Without loss of generality, only the method in FIG. 4A is described as follows.

The first derived control-point affine MVP from block B can be modified as follows:

$${V}_{0 \_ x} = {V}_{B 0 ’ \_ x} + ( {V}_{B 2 \_ x} - {V}_{B 0 ’ \_ x} ) * posCurPU\_Y - posB 0 ’ \_Y / ( 2 * N ) + ( {V}_{B 1 ’ \_ x} - {V}_{B 0 ’ \_ x} ) * posCurPU\_X - posB 0 ’ \_X / RefPU\_width , and \\ {V}_{0 \_ y} = {V}_{B 0 ’ \_ y} + ( {V}_{B 2 \_ y} - {V}_{B 0 ’ \_ y} ) * ( posCurPU\_Y - posB 0 ’ \_Y ) / ( 2 * N ) + ( {V}_{B 1 ’ \_ y} - {V}_{B 0 ’ \_ y} ) * ( posCurPU\_X - posB 0 ’ \_X ) / RefPU\_width . \qquad ( 4 )$$

In the above equations, V_{B0′}, V_{B1′}, and V_{B2} can be replaced by the corresponding MVs of any other selected reference/neighbouring PU, (posCurPU_X, posCurPU_Y) is the pixel position of the top-left sample of the current PU relative to the top-left sample of the picture, (posRefPU_X, posRefPU_Y) is the pixel position of the top-left sample of the reference/neighbouring PU relative to the top-left sample of the picture, (posB0′_X, posB0′_Y) is the pixel position of the top-left sample of the B0 block relative to the top-left sample of the picture. The other two control-point MVP can be derived as the follows.

V_{1_x}=V_{0_x}+(V_{B1′_x}−V_{B0′_x})*PU_width/RefPU_widt,h

V_{1_y}=V_{0_y}+(V_{B1′_y}−V_{B0′_y})*PU_width/RefPU_width,

V_{2_x}=V_{0_x}+(V_{B2_x}−V_{B0′_x})*PU_height/(2*N), and

V_{2_y}=V_{0_y}+(V_{B2_y}−V_{B0′_y})*PU_height/(2*N). (5)

The derived 2 control-point affine MVP from block B can be modified as follows:

$${V}_{0 \_ x} = {V}_{B 0 ’ \_ x} - ( {V}_{B 1 ’ \_ y} - {V}_{B 0 ’ \_ y} ) * ( posCurPU\_Y - posB 0 ’ \_Y ) / RefPU\_width + ( {V}_{B 1 ’ \_ x} - {V}_{B 0 ’ \_ x} ) * ( posCurPU\_X - posB 0 ’ \_X ) / RefPU\_width , \\ {V}_{0 \_ y} = {V}_{B 0 ’ \_ y} + ( {V}_{B 1 ’ \_ x} - {V}_{B 0 ’ \_ x} ) * ( posCurPU\_Y - posB 0 ’ \_Y ) / RefPU\_width + ( {V}_{B 1 ’ \_ y} - {V}_{B 0 ’ \_ y} ) * ( posCurPU\_X - posB 0 ’ \_X ) / RefPU\_width , \\ {V}_{1 \_ x} = {V}_{0 \_ x} + ( {V}_{B 1 ’ \_ x} - {V}_{B 0 ’ \_ x} ) * PU\_width / RefPU\_width , and \\ {V}_{1 \_ y} = {V}_{0 \_ y} + ( {V}_{B 1 ’ \_ y} - {V}_{B 0 ’ \_ y} ) * PU\_width / RefPU\_width . \qquad ( 6 )$$

Since the line buffer for storing the MVs from the top CTUs is much larger than the column buffer for storing the MVs from the left CTU, there is no need to constrain the value of M, where M can be set to CTU_width/N according to one embodiment.

In another embodiment, inside the current CTU row, M MV rows are used. However, outside the current CTU row, only one MV row is used. In another word, the CTU row MV line buffer only stores one MV row.

In another embodiment, different M MVs in vertical directions and/or different K MVs in horizontal direction are stored in the M MV row buffers and/or K MV column buffers. Different MVs can come from different CUs or different sub-blocks. The number of different MVs introduced from one CU with sub-block mode can be further limited in some embodiments. For example, one affine-coded CU with size 32×32 can be divided into 8 4×4 sub-blocks in the horizontal direction and 8 4×4 sub-blocks in the vertical direction. There are 8 different MVs in each direction. In one embodiment, all of these 8 different MVs are allowed to be considered as M or K different MVs. In another embodiment, only the first MV and the last MV among these 8 different MVs are considered as M or K different MVs.

### Method-3: Affine MVP Derivation by Storing One More MV Row and One More MV Column in Addition to the First Row/First Column MVs of a CU

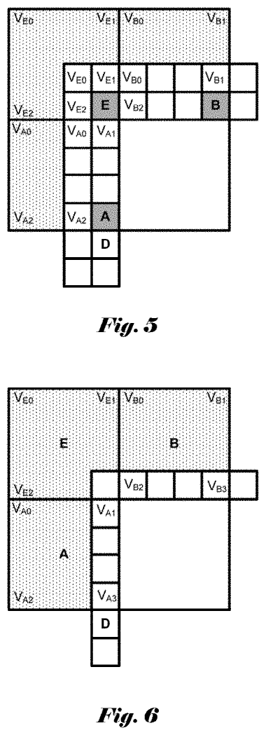

Instead of storing all MVs in the current frames, it is proposed to store one more MV row and one more MV column. As shown in FIG. 5, two MV rows and two MV columns are stored in a buffer. The first MV row and first MV column buffer that are closest to the current CU are used to store the original MV of N×N blocks. The second MV row buffer is used to store the first MV row of upper CUs, and the second MV column buffer is used to store the first MV column of the left CUs. For example, as shown in FIG. 5, the MVs of the first row MV of block B (V_{B0} to V_{B1}) are stored in the second MV row buffer. The MVs of the first column MV of block A (i.e., V_{A0} to V_{A2}) are stored in the second MV column buffer. Therefore, the MVs of the control points of a neighbouring CU can be stored in the MV buffer. The overhead is one more MV row and one more MV column.

In one embodiment, inside the current CTU row, two MV rows are used. However, outside the current CTU row, only one MV row is used. In other words, the CTU row MV line buffer is used only to store one MV row.

### Method-4: Affine MVP Derivation by Storing the Affine Parameters or Control Points for Every M×M Block or Every CU

In equations (4), the MVs of top-left and top-right control points are used to derive the MVs of all N×N sub-blocks (i.e., the smallest unit to store an MV, N=4 in one embodiment) in the CU/PU. The derived MVs are (v₀ₓ, v_{0y}) plus the position dependent offset MV. From the equations (4), if it derives an MV for an N×N sub-block, the horizontal direction offset MV is ((v₁ₓ−v₀ₓ)*N/w,(v_{1y}−v_{0y})*N/w) and the vertical direction offset MV is (−(v_{1y}−v_{0y})*N/w, (v₁ₓ−v₀ₓ)*N/w). For a 6-parameter affine model, if the top-left, top-right, and the bottom-left MVs are v₀, v₁, and V₂, the MVs of each pixel can be as follows.

$$\{ \begin{matrix}{v}_{x} = \frac{( {v}_{1 x} - {v}_{0 x} )}{w} x + \frac{( {v}_{2 x} - {v}_{0 x} )}{h} y + {v}_{0 x} \\ {v}_{y} = \frac{( {v}_{1 y} - {v}_{0 y} )}{w} x + \frac{( {v}_{2 y} - {v}_{0 y} )}{h} y + {v}_{0 y}\end{matrix} . \qquad ( 7 )$$

According to equation (7), an MV for an N×N sub-block at position (x, y) (relative to the top-left corner), the horizontal direction offset MV is ((v₁ₓ−v₀ₓ)*N/w, (v_{1y}−v_{0y})*N/w) and the vertical direction offset MV is ((v₂ₓ−v₀ₓ)*N/h, (v_{2y}−v_{0y})*N/h). The derived MV is (vₓ, v_{y}) as shown in equation (7). In equations (4) and (7), w and h are the width and height of the affine coded block.

If the MV of the control points is the MV of the centre pixel of an N×N block, in equations (4) to (7), the denominator can be decreased by N. For example, the equation (4) can be rewritten as follows.

$${V}_{0 \_ x} = {V}_{B 0 ’ \_ x} + ( {V}_{B 2 \_ x} - {V}_{B 0 ’ \_ x} ) * ( posCurPU\_Y - posB 0 ’ \_Y ) / ( N ) + ( {V}_{B 1 ’ \_ x} - {V}_{B 0 ’ \_ x} ) * ( posCurPU\_X - posB 0 ’ \_X ) / ( RefPU\_width - N ) , and \\ {V}_{0 \_ y} = {V}_{B 0 ’ \_ y} + ( {V}_{B 2 \_ y} - {V}_{B 0 ’ \_ y} ) * ( posCurPU\_Y - posB 0 ’ \_Y ) / ( N ) + ( {V}_{B 1 ’ \_ y} - {V}_{B 0 ’ \_ y} ) * ( posCurPU\_X - posB 0 ’ \_X ) / ( RefPU\_width - N ) . \qquad ( 8 )$$

In one embodiment, the horizontal and vertical direction offset MVs for an M×M block or for a CU are stored. For example, if the smallest affine Inter mode or affine Merge mode block size is 8×8, then M can be equal to 8. For each 8×8 block or a CU, if the 4-parameter affine model that uses the upper-left and upper-right control points is used, the parameters of (v₁ₓ−v₀ₓ)*N/w and (v_{1y}−v_{0y})*N/w and one MV of an N×N block (e.g. the v_{0y} and v_{0y}) are stored. If the 4-parameter affine model that uses the upper-left and bottom-left control points is used, the parameters of (v₂ₓ−v₀ₓ)*N/h and (v_{2y}−v_{0y})*N/h and one MV of an N×N block (e.g. the v_{0y} and v_{0y}) are stored. If the 6-parameter affine model that uses the upper-left, upper-right, and bottom-left control points is used, the parameters of (v₁ₓ−v₀ₓ)*N/w, (v_{1y}−v_{0y})*N/w, (v₂ₓ−v₀ₓ)*N/h, (v_{2y}−v_{0y})*N/h, and one MV of an N×N block (e.g. v_{0y} and v_{0y}) are stored. The MV of an N×N block can be any N×N block within the CU/PU. The affine parameters of the affine Merge candidate can be derived from the stored information.

In order to preserve the precision, the offset MV can be multiplied by a scale number. The scale number can be predefined or set equal to the CTU size. For example, the ((v₁ₓ−v₀ₓ)*S/w, (v_{1y}−v_{0y})*S/w) and ((v₂ₓ−v₀ₓ)*S/h, (v_{2y}−v_{0y})*S/h) are stored. The S can be equal to CTU_size or CTU_size/4.

In another embodiment, instead of storing affine parameters, the MVs of two or three control points of an MxM block or a CU, for example, are stored in a line buffer or local buffer. The control-point MV buffer and the sub-block MV buffer can be different buffers. The control-point MVs are stored separately. The control-point MV are not identical to the sub-block MVs. The affine parameters of the affine Merge candidate can be derived using the stored control points.

### Method-5: Affine MVP Derivation Using Only Two MVs of a Neighbouring Block

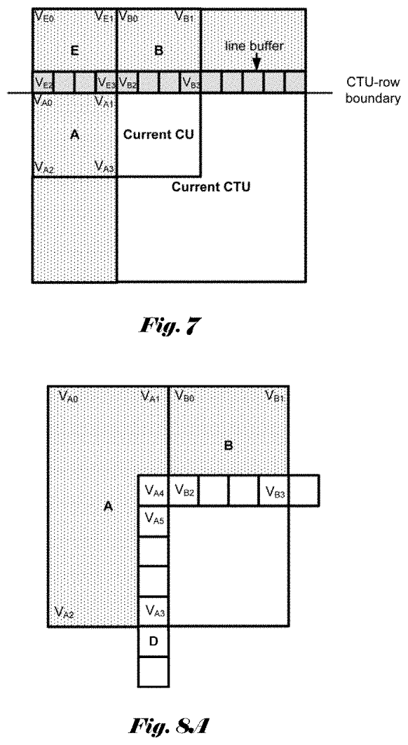

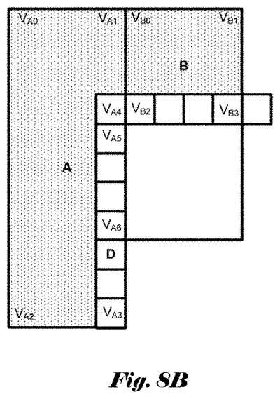

Instead of storing all MVs in the current frame, the HEVC MV line buffer design is reused according to this method. The HEVC line buffer comprises one MV row and one MV column, as shown in FIG. 6. In another embodiment, the line buffer is the CTU row MV line buffer, as shown in FIG. 7. The bottom row MVs of the above CTU row are stored.

When deriving the affine candidates from the neighbouring block, two MVs of the neighbouring blocks (e.g. two MVs of two N×N neighbouring sub-blocks of the neighbouring block, or two control-point MVs of the neighbouring block) are used. For example, in FIG. 6, for block A, V_{A1} and V_{A3} are used to derive the 4-parameter affine parameters and derive the affine Merge candidate for the current block. For block B, V_{B2} and V_{B3} are used to derive the 4-parameter affine parameters and derive the affine Merge candidate for the current block.

In one embodiment, the block E will not be used to derive the affine candidate. No additional buffer or additional line buffer is required for this method.

In another example, as shown in FIG. 8A, the left CU (i.e., CU-A) is a larger CU. If one MV line buffer is used (i.e., one MV row and one MV column), V_{A1} is not stored in the line buffer. V_{A3} and V_{A4} are used to derive the affine parameters of block A. In another example, the V_{A3} and V_{A5} are used to derive the affine parameters of block A. In another example, the V_{A3} and the average of V_{A4} and V_{A5} are used to derive the affine parameters of block A. In another example, the V_{A3} and a top-right block (referred as TR-A, not shown in FIG. 8A) in CU-A are used to derive the affine parameter, where TR-A is at a distance of power of 2. In one embodiment, the distance of V_{A3} and TR-A is power of 2. The TR-A is derived from the position of CU-A, height of CU-A, position of current CU, and/or height of current CU. For example, a variable height_{A} is first defined as equal to the height of CU-A. Then, whether the position of V_{A3} block—height_{A} is equal to or smaller than the y-position of the top-left position of the current CU is checked. If the result is false, the height_{A} is divided by 2, and whether the position of V_{A3} block—height_{A} is equal to or smaller than the y-position of the top-left position of the current CU is checked. If the condition is satisfied, the block of V_{A3} and the block with the position of V_{A3} block—height_{A} are used to derive the affine parameters of block A.

In FIG. 8B, the V_{A3} and V_{A4} are used to derive the affine parameters of block A. In another example, the V_{A3} and V_{A5} are used to derive the affine parameters of block A. In another example, the V_{A3} and the average of V_{A4} and V_{A5} are used to derive the affine parameters of block A. In another example, the V_{A5} and V_{A6}, where distance of these two blocks are equal to the current CU height or width, are used to derive the affine parameters of block A. In another example, the V_{A4} and V_{A6}, where distance of these two blocks is equal to the current CU height or width+one sub-block, are used to derive the affine parameters of block A. In another example, the V_{A5} and D are used to derive the affine parameters of block A. In another example, the V_{A4} and D are used to derive the affine parameters of block A. In another example, the average of V_{A4} and V_{A5} and the average of V_{A6} and D are used to derive the affine parameters of block A. In another example, it picks two blocks with distance equal to power of 2 of sub-block width/height for deriving the affine parameter. In another example, it picks two blocks with distance equal to power of 2 of sub-block width/height+one sub-block width/height for deriving the affine parameter. In another example, the V_{A3} and a top-right block (TR-A) in CU-A are used to derive the affine parameter. In one embodiment, the distance of V_{A3} and TR-A is power of 2. The TR-A is derived from the position of CU-A, height of CU-A, position of current CU, and/or height of current CU. For example, a variable height_{A} is first defined as equal to the height of CU-A. Whether the position of V_{A3} block—height_{A} is equal to or smaller than the y-position of the top-left position of the current CU is checked. If the result is false, the height_{A} is divided by 2, and whether the position of V_{A3} block—height_{A} is equal to or smaller than the y-position of the top-left position of the current CU is checked. If the condition is satisfied, the block of V_{A3} and the block with the position of position of V_{A3} block—height_{A} are used to derive the affine parameters of block A. In another example, the V_{A6}/D/or average of V_{A6} and D and a top-right block (TR-A) in CU-A are used to derive the affine parameters. In one embodiment, the distance of V_{A6} and TR-A is power of 2. The TR-A is derived from the position of CU-A, height of CU-A, position of current CU, and/or height of current CU. For example, a variable height_{A} is first defined as equal to the height of CU-A. Then, it checks whether the position of V_{A6} block—height_{A} is equal to or smaller than the y-position of the top-left position of the current CU. If the result is false, the height_{A} is divided by 2, and whether the position of V_{A6} block—height_{A} is equal to or smaller than the y-position of the top-left position of the current CU is checked. If the condition is satisfied, the block of V_{A6} and the block with the position of position of V_{A6} block—height_{A} are used to derive the affine parameters of block A.

In another embodiment, for FIG. 8, the MV of V_{A1} is stored in the buffer marked as V_{A4}. Then, the V_{A1} and V_{A3} can be used to derive the affine parameters. In another example, this kind of large CU is not used for deriving the affine parameter.

Note that the above mentioned methods use the left CUs to derive the affine parameters or control-points MVs for the current CU. The proposed methods can also be used for deriving the affine parameters or control-point MVs for the current CU from the above CUs by using the same/similar methods.

The derived 2 control-points (i.e., 4-parameter) affine MVP from block B can be modified as follow:

$${V}_{0 \_ x} = {V}_{B 2 \_ x} - ( {V}_{B 3 \_y} - {V}_{B 2 \_ y} ) * ( posCurPU\_Y - posB2\_Y ) / {RefPU}_{B} \_width + ( {V}_{B 3 \_ x} - {V}_{B 2 \_ x} ) * ( posCurPU\_X - posB2\_X ) / {RefPU}_{B} \_width , \\ {V}_{0 \_ y} = {V}_{B 2 \_ y} + ( {V}_{B 3 \_ x} - {V}_{B 2 \_ x} ) * ( posCurPU\_Y - posB2\_Y ) / {RefPU}_{B} \_width + ( {V}_{B 3 \_ y} - {V}_{B 2 \_ y} ) * ( posCurPU\_X - posB2\_X ) / {RefPU}_{B} \_width , \\ {V}_{1 \_ x} = {V}_{0 \_ x} + ( {V}_{B 3 \_ x} - {V}_{B 2 \_ x} ) * PU\_width / {PU\_RefPU}_{B} \_width or \\ {V}_{1 \_ x} = {V}_{B 2 \_ x} - ( {V}_{B 3 \_ y} - {V}_{B 2 \_ y} ) * ( posCurPU\_Y - posB2\_Y ) / {RefPU}_{B } \_width + ( {V}_{B 3 \_ x} - {V}_{B 2 \_ x} ) * ( posCurPU\_TR \_X - posB2\_X ) / {RefPU}_{B} \_width , or \\ {V}_{1 \_ x} = {V}_{B 2 \_ x} - ( {V}_{B 3 \_y} - {V}_{B 2 \_ y} ) * ( posCurPU\_TR \_Y - posB2\_Y ) / {RefPU}_{B} \_width + ( {V}_{B 3 \_ x} - {V}_{B 2 \_ x} ) * ( posCurPU\_TR \_X - posB2\_X ) / {RefPU}_{B } \_width , \\ {V}_{1 \_ y} = {V}_{0 \_ y} + ( {V}_{B 3 \_ y} - {V}_{B 2 \_ y} ) * PU\_width / {RefPU}_{B} \_width or {V}_{1 \_ y} = {V}_{B 2 \_ y} + ( {V}_{B 3 \_ x} - {V}_{B 2 \_ x} ) * ( posCurPU\_Y - posB2\_Y ) / {RefPU}_{B} \_width + ( {V}_{B 3 \_ y} - {V}_{B 2 \_ y} ) * ( posCurPU\_TR \_X - posB2\_X ) / {RefPU}_{B} \_width , or \\ {V}_{1 \_ y} = {V}_{B 2 \_ y} + ( {V}_{B 3 \_ x} - {V}_{B 2 \_ x} ) * ( posCurPU\_TR \_Y - posB2\_Y ) / {RefPU}_{B} \_width + ( {V}_{B 3 \_ y} - {V}_{B 2 \_ y} ) * ( posCurPU\_TR \_X - posB2\_X ) / {RefPU}_{B} \_width . \qquad ( 9 )$$

Alternatively, we can use the equation below:

$${V}_{0 \_ x} = {V}_{B 2 \_ x} - ( {V}_{B 3 \_ y} - {V}_{B 2 \_ y} ) * ( posCurPU\_Y - posB2\_Y ) / ( posB3\_X - posB2\_X ) + ( {V}_{B 3 \_ x} - {V}_{B 2 \_ x} ) * ( posCurPU\_X - posB2\_X ) / ( posB3\_X - posB2\_X ) , \\ {V}_{0 \_ y} = {V}_{B 2 \_ y} + ( {V}_{B 3 \_ x} - {V}_{B 2 \_ x} ) * ( posCurPU\_Y - posB2\_Y ) / ( posB3\_X - posB2\_X ) + ( {V}_{B 3 \_ y} - {V}_{B 2 \_ y} ) * ( posCurPU\_X - posB2\_X ) / ( posB3\_X - posB2\_X ) , \\ {V}_{1 \_ x} = {V}_{0 \_ x} + ( {V}_{B 3 \_ x} - {V}_{B 2 \_ x} ) * PU\_width / ( posB3\_X - posB2\_X ) , \\ {V}_{1 \_ x} = {V}_{B 2 \_ x} - ( {V}_{B 3 \_ y} - {V}_{B 2 \_ y} ) * ( posCurPU\_Y - posB2\_Y ) / ( posB3\_X - posB2\_X ) + ( {V}_{B 3 \_ x} - {V}_{B 2 \_ x} ) * ( posCurPU\_TR \_X - posB2\_X ) / ( posB3\_X - posB2\_X ) , or \\ {V}_{1 \_ x} = {V}_{B 2 \_ x} - ( {V}_{B 3 \_ y} - {V}_{B 2 \_ y} ) * ( posCurPU\_TR \_Y - posB2\_Y ) / ( posB3\_X - posB2\_X ) + ( {V}_{B 3 \_ x} - {V}_{B 2 \_ x} ) * ( posCurPU\_TR \_X - posB2\_X ) / ( posB3\_X - posB2\_X ) , \\ {V}_{1 \_ y} = {V}_{0 \_ y} + ( {V}_{B 3 \_ y} - {V}_{B 2 \_ y} ) * PU\_width / ( posB3\_X - posB2\_X ) , or {V}_{1 \_ y} = {V}_{B 2 \_ y} + ( {V}_{B 3 \_ x} - {V}_{B 2 \_ x} ) * ( posCurPU\_Y - posB2\_Y ) / ( posB3\_X - posB2\_X ) + ( {V}_{B 3 \_ y} - {V}_{B 2 \_ y} ) * ( posCurPU\_TR \_X - posB2\_X ) / ( posB3\_X - posB2\_X ) , or \\ {V}_{1 \_ y} = {V}_{B 2 \_ y} + ( {V}_{B 3 \_ x} - {V}_{B 2 \_ x} ) * ( posCurPU\_TR \_Y - posB2\_Y ) / ( posB3\_X - posB2\_X ) + ( {V}_{B 3 \_ y} - {V}_{B 2 \_ y} ) * ( posCurPU\_TR \_X - posB2\_X ) / ( posB3\_X - posB2\_X ) . \qquad ( 10 )$$

In the above equation, V_{B0′}, V_{B1′}, and V_{B2} can be replaced by the corresponding MVs of any other selected reference/neighbouring PU, (posCurPU_X, posCurPU_Y) is the pixel position of the top-left sample of the current PU relative to the top-left sample of the picture, (posCurPU_TR_X, posCurPU_TR_Y) is the pixel position of the top-right sample of the current PU relative to the top-left sample of the picture, (posRefPU_X, posRefPU_Y) is the pixel position of the top-left sample of the reference/neighbouring PU relative to the top-left sample of the picture, (posB0′_X, posB0′_Y) are the pixel position of the top-left sample of the B0 block relative to the top-left sample of the picture.

In one embodiment, the proposed method, which uses two MVs for deriving the affine parameters or only using MVs stored in the MV line buffer for deriving the affine parameters, is applied to a neighbouring region. Inside the current region of the current block, the MVs are all stored (e.g. all the sub-block MVs or all the control-point MVs of the neighbouring blocks) and can be used for deriving the affine parameters. If the reference MVs are outside of the region (i.e., in the neighbouring region), the MVs in the line buffer (e.g. CTU row line buffer, CU row line buffer, CTU column line buffer, and/or CU column line buffer) can be used. The 6-parameter affine model is reduced to 4-parameter affine model in the case that not all control-point MVs are available. For example, two MVs of the neighbouring blocks are used to derive the affine control point MV candidate of the current block. The MVs of the target neighbouring block can be a bottom-left sub-block MV and a bottom-right sub-block MV of the neighbouring block or two control point MVs of the neighbouring block. When the reference MVs are inside the region (i.e., the current region), the 6-parameter affine model or 4-parameter affine model or other affine model can be used.

The region boundary associated with the neighbouring region can be CTU boundary, CTU-row boundary, tile boundary, or slice boundary. For example, for the MVs above the current CTU-row, the MVs stored in the one row MV buffer (e.g. the MVs of the above row of the current CTU row) can be used (e.g. the V_{B0} and V_{B1} in FIG. 7 are not available, but the V_{B2} and V_{B3} are available). The MVs with the current CTU row can be used. The sub-block MVs of V_{B2} and V_{B3} are used to derive the affine parameters or control-point MVs or control-point MVPs (MV predictors) of the current block if the neighbouring reference block (the block-B) is in the above CTU row (not in the same CTU row with the current block). If the neighbouring reference block is in the same CTU row with the current block (e.g. inside the region), the sub-block MVs of the neighbouring block or the control-point MVs of the neighbouring block can be used to derive the affine parameters or control-point MVs or control-point MVPs (MV predictors) of the current. In one embodiment, if the reference block is in the above CTU row, the 4-parameter affine model is used to derive the affine control point MVs since only two MVs are used for deriving the affine parameter. For example, two MVs of the neighbouring blocks are used to derive the affine control point MV candidate of the current block. The MVs of the target neighbouring block can be a bottom-left sub-block MV and a bottom-right sub-block MV of the neighbouring block or two control point MVs of the neighbouring block. Otherwise, the 6-parameter affine model or 4-parameter affine model (according to the affine model used in the neighbouring block) or other affine model can be used to derive the affine control point MVs.

In another example, for the MVs above the current CTU-row, the MVs of the above row of the current CTU and the right CTUs, and the MVs with the current CTU row can be used. The MV in the top-left CTUs cannot be used. In one embodiment, if the reference block is in the above CTU or the above-right CTUs, the 4-parameter affine model is used. If the reference block is in the top-left CTU, the affine model is not used. Otherwise, the 6-parameter affine model or 4-parameter affine model or other affine model can be used.

In another example, the current region can be the current CTU and the left CTU. The MVs in current CTU, the MVs of the left CTU, and one MV row above current CTU, left CTU and right CTUs can be used. In one embodiment, if the reference block is in the above CTU row, the 4-parameter affine model is used. Otherwise, the 6-parameter affine model or 4-parameter affine model or other affine model can be used.

In another example, the current region can be the current CTU and the left CTU. The MVs in current CTU, the MVs of the left CTU, and one MV row above current CTU, left CTU and right CTUs can be used. The top-left neighbouring CU of the current CTU cannot be used for derive the affine parameters. In one embodiment, if the reference block is in the above CTU row or in the left CTU, the 4-parameter affine model is used. If the reference block is in the top-left CTU, the affine model is not used. Otherwise, the 6-parameter affine model or 4-parameter affine model or other affine model can be used.

In another example, the current region can be the current CTU. The MVs in the current CTU, the MVs of the left column of the current CTU, and the MVs of the above row of the current CTU can be used for deriving the affine parameters. The MVs of the above row of the current CTU may also include the MVs of the above row of the right CTUs. In one embodiment, the top-left neighbouring CU of the current CTU cannot be used for deriving the affine parameter. In one embodiment, if the reference block is in the above CTU row or in the left CTU, the 4-parameter affine model is used. If the reference block is in the top-left CTU, the affine model is not used. Otherwise, the 6-parameter affine model or 4-parameter affine model or other affine model can be used.

In another example, the current region can be the current CTU. The MVs in the current CTU, the MVs of the left column of the current CTU, the MVs of the above row of the current CTU and the top-left neighbouring MV of the current CTU can be used for deriving the affine parameters. The MVs of the above row of the current CTU may also include the MVs of the above row of the right CTUs. Note that, in one example, the MVs of the above row of the left CTU are not available. In another example, the MVs of the above row of the left CTU except for the top-left neighbouring MV of the current CTU are not available. In one embodiment, if the reference block is in the above CTU row or in the left CTU, the 4-parameter affine model is used. Otherwise, the 6-parameter affine model or 4-parameter affine model or other affine model can be used.

In another example, the current region can be the current CTU. The MVs in the current CTU, the MVs of the left column of the current CTU, the MVs of the above row of the current CTU (in one example, including the MVs of the above row of the right CTUs and the MVs of the above row of the left CTU), and the top-left neighbouring MV of the current CTU can be used for deriving the affine parameters. In one embodiment, the top-left neighbouring CU of the current CTU cannot be used for derive the affine parameters.

In another example, the current region can be the current CTU. The MVs in the current CTU, the MVs of the left column of the current CTU, the MVs of the above row of the current CTU can be used for deriving the affine parameters. In another example, the MVs of the above row of the current CTU includes the MVs of the above row of the right CTUs but excluding the MVs of the above row of the left CUs. In one embodiment, the top-left neighbouring CU of the current CTU cannot be used for derive the affine parameter.

For 4-parameter affine model, the MVx and MVy (vₓ and v_{y}) are derived by four parameters (a, b, e, and f) such as the following equation.

$$\{ \begin{matrix}{v}_{x} = ax + by + e \\ {v}_{y} = - bx + ay + f\end{matrix} \qquad ( 11 )$$

According to the x and y position of a target point and the four parameters, the vₓ and v_{y} can be derived. In four parameter model, the y-term parameter of vₓ is equal to x-term parameter of v_{y} multiplied by −1. The x-term parameter of vₓ and y-term parameter of v_{y} are the same. According to equation (4), the a can be (v₁ₓ−v₀ₓ)/w, b can be −(v_{1y}−v_{0y})/w, e can be v₀ₓ, f can be v_{0y}.

For 6-parameter affine model, the MVx and MVy (vₓ and v_{y}) are derived by six parameters (a, b, c, d, e, and f) such as the following equation.

$$\{ \begin{matrix}{v}_{x} = a x + b y + e \\ {v}_{y} = c x + d y + f\end{matrix} \qquad ( 12 )$$

According to the x and y position of a target point and the six parameters, the vₓ and v_{y} can be derived. In six parameter model, the y-term parameter of vₓ and x-term parameter of v_{y} are different. The x-term parameter of vₓ and y-term parameter of v_{y} are also the different. According to equation (4), the a can be (v₁ₓ−v₀ₓ)/w, b can be (v₂ₓ−v₀ₓ)/h, c can be (v_{1y}−v_{0y})/w, d can be (v_{2y}−v_{0y})/h, e can be v₀ₓ, f can be v_{0y}.

The proposed method that only uses partial MV information (e.g. only two MVs) to derive the affine parameters or control-point MVs/MVPs can be combined with the method that stores the affine control-point MVs separately. For example, a region is first defined. If the reference neighbouring block is in the same region (i.e., the current region), the stored control-point MVs of the reference neighbouring block can be used to derive the affine parameters or control-point MVs/MVPs of the current block. If the reference neighbouring block is not in the same region (i.e., in the neighbouring region), only the partial MV information (e.g. only two MVs of the neighbouring block) can be used to derive the affine parameters or control-point MVs/MVPs of the current block. The two MVs of the neighbouring block can be the two sub-block MVs of the neighbouring block. The region boundary can be CTU boundary, CTU-row boundary, tile boundary, or slice boundary. In one example, the region boundary can be CTU-row boundary. If the neighbouring reference block is not in the same region (e.g. the neighbouring reference block in the above CTU row), only the two MVs of the neighbouring block can be used to derive the affine parameters or control-point MVs/MVPs. The two MVs can be the bottom-left and the bottom-right sub-block MVs of the neighbouring block. In one example, if the neighbouring block is bi-predicted block, the List-0 and List-1 MVs of the bottom-left and the bottom-right sub-block MVs of the neighbouring block can be used to derive the affine parameters or control-point MVs/MVPs of the current block. Only the 4-parameter affine model is used. If the neighbouring reference block is in the same region (e.g. in the same CTU row with the current block), the stored control-point MVs of the neighbouring block can be used to derive the affine parameters or control-point MVs/MVPs of the current block. The 6-parameter affine model or 4-parameter affine model or other affine models can be used depending on the affine model used in the neighbouring block.

In this proposed method, it uses two neighbouring MVs to derive the 4-parameter affine candidate. In another embodiment, we can use the two neighbouring MVs and one additional MV to derive the 6-parameter affine candidates. The additional MV can be one of the neighbouring MVs or one of the temporal MVs. Therefore, if the neighbouring block is in the above CTU row or not in the same region, the 6-parameter affine model still can be used to derive the affine parameters or control-point MVs/MVPs of the current block.

In one embodiment, 4- or 6-parameter affine candidate is derived depending on the affine mode and/or the neighbouring CUs. For example, in affine AMVP mode, one flag or one syntax is derived or signalled to indicate the 4- or 6-parameter being used. The flag or syntax can be signalled in the CU level, slice-level, picture level or sequence level. If the 4-parameter affine mode is used, the above mentioned method is used. If the 6-parameter affine mode is used and not all control-point MVs of the reference block are available (e.g. the reference block being in above CTU row), the two neighbouring MVs and one additional MV are used to derive the 6-parameter affine candidate. If the 6-parameter affine mode is used and all control-point MVs of the reference block are available (e.g. the reference block being in current CTU) the three control-point MVs of the reference block are used to derive the 6-parameter affine candidate.

In another example, the 6-parameter affine candidate is always used for affine Merge mode. In another example, the 6-parameter affine candidate is used when the referencing affine coded block is coded in the 6-parameter affine mode (e.g. 6-parameter affine AMVP mode or Merge mode). The 4-parameter affine candidate is used when the referencing affine coded block is coded in 4-parameter affine mode. For deriving the 6-parameter affine candidate, if not all control-point MVs of the reference block are available (e.g. the reference block being in the above CTU row), the two neighbouring MVs and one additional MV are used to derive the 6-parameter affine candidate. If all control-point MVs of the reference block are available (e.g. the reference block being in the current CTU), the three control-point MVs of the reference block are used to derive the 6-parameter affine candidate.

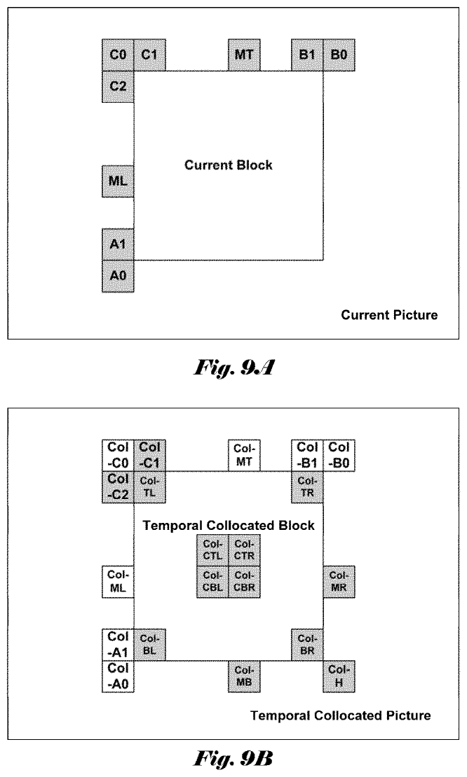

In one embodiment, the additional MV is from the neighbouring MVs. For example, if the MVs of the above CU are used, the MV of the bottom-left neighbouring MV (A0 or A1 in FIG. 9A, or the first available MV in block A0 and A1 with scan order {A0 to A1} or {A1 to A0}) can be used to derive the 6-parameter affine mode. If the MVs of the left CU are used, the MV of the top-right neighbouring MV (B0 or B1 in FIG. 9A, or the first available MV in block B0 and B1 with scan order {B0 to B1} or {B1 to B0}) can be used to derive the 6-parameter affine mode. In one example, if the two neighbouring MVs are V_{B2} and V_{B3} as shown in FIG. 6, the additional MV can be one neighbouring MV in the bottom-left corner (e.g. V_{A3} or D). In another example, if the two neighbouring MVs are V_{A1} and V_{A3}, the additional MV can be one neighbouring MV in the bottom-left corner (e.g. V_{B3} or the MV right to the V_{B3}).

In another embodiment, the additional MV is from the temporal collocated MVs. For example, the additional MV can be the Col-BR, Col-H, Col-BL, Col-A1, Col-A0, Col-B0, Col-B1, Col-TR in FIG. 9B. In one example, when the two neighbouring MVs are from the above or left CU, the Col-BR or Col-H is used. In another example, when the two neighbouring MVs are from the above CU, the Col-BL, Col-A1, or Col-A0 is used. In another example, when the two neighbouring MVs are from the left CU, the Col-B0, Col-B1, or Col-TR is used.

In one embodiment, whether to use the spatial neighbouring MV or the temporal collocated MV depends on the spatial neighbouring and/or the temporal collocated block. In one example, if the spatial neighbouring MV is not available, the temporal collocated block is used. In another example, if the temporal collocated MV is not available, the spatial neighbouring block is used.

### Control-Point MV Storage

In affine motion modelling, control-point MVs are first derived. The current block is then divided into multiple sub-blocks. The derived representative MV of the each sub-block is derived from the control-point MVs. In JEM, the Joint Exploration Test Model, the representative MV each sub-block is used for motion compensation. The representative MV is derived by using the centre point of the sub-block. For example, for a 4×4 block, the (2, 2) sample of the 4×4 block is used to derive the representative MV. In the MV buffer storage, for the four corners of the current block, the representative MVs of the four corners are replaced by control-points MVs. The stored MVs are used for MV referencing of the neighbouring block. This causes confusion since the stored MVs (e.g. control-point MVs) and the compensation MV (e.g. the representative MVs) for the four corners are different.

In this invention, it is proposed to store the representative MV in the MV buffer instead of control-point MVs in the four corners of the current block. In this way, it doesn't need to re-derive the compensation MVs for four corner sub-blocks or doesn't need additional MV storage for the four corners. However, the affine MV derivation needs to be modified since the denominator of the scaling factor in affine MV derivation is not a power-of-2 value. The modification can be addressed as the follows. Also, the reference sample positions in the equations are also modified according to embodiments of the present invention.

In one embodiment, the control-points MVs of the corners of the current block (e.g. top-left/top-right/bottom-left/bottom-right samples of the current block) are derived as affine MVPs (e.g. AMVP MVP candidate and/or affine Merge candidates). From the control-point MVs, the representative MV of each sub-block is derived and stored. The representative MVs are used for MV/MVP derivation and MV coding of neighbouring block and collocated blocks.

In another embodiment, the representative MVs of some corner sub-blocks are derived as affine MVPs. From the representative MVs of the corner sub-blocks, the representative MVs of each sub-block is derived and stored. The representative MVs are used for MV/MVP derivation and MV coding of neighbouring block and collocated blocks.

### MV Scaling for Affine Control-Point MV Derivation

In this invention, to derive the affine control-point MVs, the MV difference (e.g. V_{B2_x}−V_{B0′_x}) is multiplied by a scaling factor (e.g. (posCurPU_Y−posB2_Y)/RefPU_{B}_width and (posCurPU_Y−posB2_Y)/(posB3_X−posB2_X) in equation (9). If the denominator of the scaling factor is a power-of-2 value, the simple multiplication and shift can be applied. However, if the denominator of the scaling factor is not a power-of-2 value, a divider is required. Usually, the implementation of a divider requires a lot of silicon area. To reduce the implementation cost, the divider can be replaced by look-up table, multiplier, and shifter according to embodiments of the present invention. Since the denominator of the scaling factor is the control-point distance of the reference block, the value is smaller than CTU size and is related to the possible CU size. Therefore, the possible values of the denominator of the scaling factor are limited. For example, the value can be power of 2 minus 4, such as 4, 12, 28, 60 or 124. For these denominators (denoted as D), a list of beta values can be predefined. The “N/D” can be replace by N*K>>L , where the N is the numerator of the scaling factor and “>>” corresponds to the right shift operation. The L can be a fixed value. The K is related to D and can be derived from a look-up table. For example, for a fixed L, the K value depends on D and can be derived using Table 1 or Table 2 below. For example, the L can be 10. The K value is equal to {256, 85, 37, 17, 8} for the D equal to {4, 12, 28, 60, 124} respectively.

TABLE 1

| | | L | | | | | | | |
|---|---|---|---|---|---|---|---|---|---|
| | | K = | | | | | | | |
| | | 7 | 8 | 9 | 10 | 11 | 12 | 13 | 14 |
| D | 4 | 32 | 64 | 128 | 256 | 512 | 1024 | 1536 | 2048 |
| | 12 | 11 | 21 | 43 | 85 | 171 | 341 | 512 | 683 |
| | 28 | 5 | 9 | 18 | 37 | 73 | 146 | 219 | 293 |
| | 60 | 2 | 4 | 9 | 17 | 34 | 68 | 102 | 137 |
| | 124 | 1 | 2 | 4 | 8 | 17 | 33 | 50 | 66 |

TABLE 2

| | | L | | | | | | | |
|---|---|---|---|---|---|---|---|---|---|
| | | K = | | | | | | | |
| | | 7 | 8 | 9 | 10 | 11 | 12 | 13 | 14 |
| D | 4 | 32 | 64 | 128 | 256 | 512 | 1024 | 1536 | 2048 |
| | 12 | 11 | 22 | 43 | 86 | 171 | 342 | 513 | 683 |
| | 28 | 5 | 10 | 19 | 37 | 74 | 147 | 220 | 293 |
| | 60 | 3 | 5 | 9 | 18 | 35 | 69 | 103 | 137 |
| | 124 | 2 | 3 | 5 | 9 | 17 | 34 | 50 | 67 |

In another embodiment, the scaling factor can be replaced by the factor derived using the MV scaling method as used in AMVP and/or Merge candidate derivation. The MV scaling module can be reused. For example, the motion vector, my is scaled as follows:

tx=(16384+(Abs(td)>>1))/td

distScaleFactor=Clip3(−4096, 4095, (tb*tx+32)>>6)

mv=Clip3(−32768, 32767, Sign(distScaleFactor*mvLX)*((Abs(distScaleFactor*mvLX)+127)>>8))

In the above equations, td is equal to denominator and tb is equal to the numerator. For example, the tb can be the (posCurPU_Y−posB2_Y) and the td can be the (posB3_X−posB2_X) in equation (9).

Note that, in this invention, the derived control-points MVs or the affine parameters can be used for Inter mode coding as the MVP or the Merge mode coding as the affine Merge candidates.

Any of the foregoing proposed methods can be implemented in encoders and/or decoders. For example, any of the proposed methods can be implemented in MV derivation module of an encoder, and/or an MV derivation module of a decoder. Alternatively, any of the proposed methods can be implemented as a circuit coupled to the MV derivation module of the encoder and/or the MV derivation module of the decoder, so as to provide the information needed by the MV derivation module.

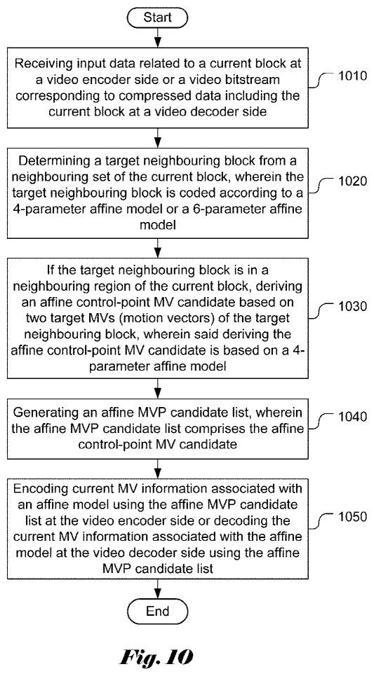

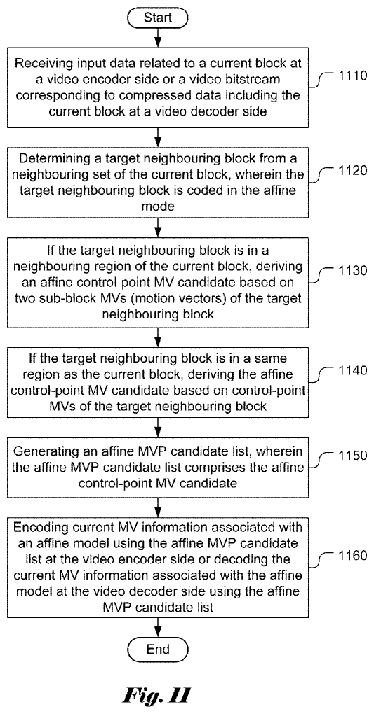

FIG. 10 illustrates an exemplary flowchart for a video coding system with an affine Inter mode incorporating an embodiment of the present invention, where the affine control-point MV candidate is derived based on two target MVs (motion vectors) of the target neighbouring block and the affine control-point MV candidate is based on a 4-parameter affine model. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, input data related to a current block is received at a video encoder side or a video bitstream corresponding to compressed data including the current block is received at a video decoder side in step 1010. A target neighbouring block is determined from a neighbouring set of the current block in step 1020, wherein the target neighbouring block is coded according to a 6-parameter affine model. If the target neighbouring block is in a neighbouring region of the current block, an affine control-point MV candidate based on two target MVs (motion vectors) of the target neighbouring block is derived in step 1030, wherein the affine control-point MV candidate is based on a 4-parameter affine model. An affine MVP candidate list is generated in step 1040, wherein the affine MVP candidate list comprises the affine control-point MV candidate. The current MV information associated with an affine model is encoded using the affine MVP candidate list at the video encoder side or the current MV information associated with the affine model is decoded at the video decoder side using the affine MVP candidate list in step 1050.

FIG. 11 illustrates another exemplary flowchart for a video coding system with an affine Inter mode incorporating an embodiment of the present invention, where the affine control-point MV candidate is derived based on stored control-point motion vectors or sub-block motion vector depending on whether the target neighbouring block is in the neighbouring region or the same region of the current block. According to this method, input data related to a current block is received at a video encoder side or a video bitstream corresponding to compressed data including the current block is received at a video decoder side in step 1110. A target neighbouring block from a neighbouring set of the current block is determined in step 1120, wherein the target neighbouring block is coded in the affine mode. If the target neighbouring block is in a neighbouring region of the current block, an affine control-point MV candidate is derived based on two sub-block MVs (motion vectors) of the target neighbouring block in step 1130. If the target neighbouring block is in a same region as the current block, the affine control-point MV candidate based on control-point MVs of the target neighbouring block is derived in step 1140. An affine MVP candidate list is generated in step 1150, wherein the affine MVP candidate list comprises the affine control-point MV candidate. The current MV information associated with an affine model is encoded using the affine MVP candidate list at the video encoder side or the current MV information associated with the affine model is decoded at the video decoder side using the affine MVP candidate list in step 1160.

The flowcharts shown are intended to illustrate an example of video according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be a circuit integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of Inter prediction for video coding performed by a video encoder or a video decoder that utilizes MVP (motion vector prediction) to code MV (motion vector) information associated with a block coded with coding modes including an affine mode, the method comprising:
receiving input data related to a current block at a video encoder side or a video bitstream corresponding to compressed data including the current block at a video decoder side;
determining a target neighbouring block from a neighbouring set of the current block, wherein the target neighbouring block is coded according to a 4-parameter affine model or a 6-parameter affine model;
if the target neighbouring block is in a neighbouring region of the current block, deriving an affine control-point MV candidate based on two target MVs (motion vectors) of the target neighbouring block, wherein said deriving the affine control-point MV candidate is based on a 4-parameter affine model;
generating an affine MVP candidate list, wherein the affine MVP candidate list comprises the affine control-point MV candidate; and
encoding current MV information associated with an affine model using the affine MVP candidate list at the video encoder side or decoding the current MV information associated with the affine model at the video decoder side using the affine MVP candidate list.

2. The method of claim 1, wherein a region boundary associated with the neighbouring region of the current block corresponds to a CTU boundary, CTU-row boundary, tile boundary, or slice boundary of the current block.

3. The method of claim 1, wherein the neighbouring region of the current block corresponds to an above CTU (coding tree unit) row of the current block or one left CTU column of the current block.

4. The method of claim 1, wherein the neighbouring region of the current block corresponds to an above CU (coding unit) row of the current block or one left CU column of the current block.

5. The method of claim 1, wherein the two target MVs of the target neighbouring block correspond to two sub-block MVs of the target neighbouring block.

6. The method of claim 5, wherein the two sub-block MVs of the target neighbouring block correspond to a bottom-left sub-block MV and a bottom-right sub-block MV.

7. The method of claim 5, wherein the two sub-block MVs of the target neighbouring block are stored in a line buffer.

8. The method of claim 7, wherein one row of MVs above the current block and one column of MVs to a left side of the current block are stored in the line buffer.

9. The method of claim 7, wherein one bottom row of MVs of an above CTU row of the current block are stored in the line buffer.

10. The method of claim 1, wherein the two target MVs of the target neighbouring block correspond to two control-point MVs of the target neighbouring block.

11. The method of claim 1, further comprising deriving the affine control-point MV candidate and including the affine control-point MV candidate in the affine MVP candidate list if the target neighbouring block is in a same region as the current block, wherein said deriving the affine control-point MV candidate is based on a 6-parameter affine model or the 4-parameter affine model.

12. The method of claim 11, wherein the same region corresponds to a same CTU row.

13. The method of claim 1, wherein y-term parameter of MV x-component is equal to x-term parameter of MV y-component multiplied by (−1), and x-term parameter of MV x-component and y-term parameter of MV y-component are the same for the 4-parameter affine model.

14. The method of claim 1, wherein y-term parameter of MV x-component and x-term parameter of MV y-component are different, and x-term parameter of MV x-component and y-term parameter of MV y-component are also different for the 6-parameter affine model.

15. (canceled)

16. A method of Inter prediction for video coding performed by a video encoder or a video decoder that utilizes MVP (motion vector prediction) to code MV (motion vector) information associated with a block coded with coding modes including an affine mode, the method comprising:
receiving input data related to a current block at a video encoder side or a video bitstream corresponding to compressed data including the current block at a video decoder side;
determining a target neighbouring block from a neighbouring set of the current block, wherein the target neighbouring block is coded in the affine mode;
if the target neighbouring block is in a neighbouring region of the current block, deriving an affine control-point MV candidate based on two sub-block MVs (motion vectors) of the target neighbouring block;
if the target neighbouring block is in a same region as the current block, deriving the affine control-point MV candidate based on control-point MVs of the target neighbouring block;
generating an affine MVP candidate list, wherein the affine MVP candidate list comprises the affine control-point MV candidate; and
encoding current MV information associated with an affine model using the affine MVP candidate list at the video encoder side or decoding the current MV information associated with the affine model at the video decoder side using the affine MVP candidate list.

17. The method of claim 16, wherein a region boundary associated with the neighbouring region of the current block corresponds to CTU boundary, CTU-row boundary, tile boundary, or slice boundary of the current block.

18. The method of claim 16, wherein the neighbouring region of the current block corresponds to an above CTU (coding tree unit) row of the current block or one left CTU column of the current block.

19. The method of claim 16, wherein the neighbouring region of the current block corresponds to an above CU (coding unit) row of the current block or one left CU column of the current block.

20. The method of claim 16, wherein the two sub-block MVs of the target neighbouring block correspond to a bottom-left sub-block MV and a bottom-right sub-block MV.

21. The method of claim 16, wherein if the target neighbouring block is a bi-predicted block, bottom-left sub-block MVs and bottom-right sub-block MVs associated with list 0 and list 1 reference pictures are used for deriving the affine control-point MV candidate.

22. The method of claim 16, if the target neighbouring block is in the same region as the current block, said deriving the affine control-point MV candidate is based on a 6-parameter affine model or a 4-parameter affine model depending on the affine mode of the target neighbouring block.

23. The method of claim 16, wherein the same region corresponds to a same CTU row.

24. (canceled)
